(19) United States
(12) Patent Application Publication
(10) Pub. No.: US 2019/0366310 A1
(43) Pub. Date: Dec. 5, 2019

(54) SULPHONIC ACID SALTS FOR METAL CATALYST PREPARATION

(71) Applicant: ARKEMA FRANCE, Colombes (FR)

(72) Inventors: Bernard MONGUILLON, Bayonne (FR); Zsolt MOLNAR, Dunaharaszti (HU)

(73) Assignee: ARKEMA FRANCE, Colombes (FR)

(21) Appl. No.: 16/462,329

(22) PCT Filed: Nov. 20, 2017
(86) PCT No.: PCT/FR2017/053171

§ 371 Date: May 20, 2019

(30) Foreign Application Priority Data
Nov. 24, 2016 (FR) 1661426

(51) Int. Cl. B01J 27/051; B01J 37/20; C10G 45/12; C10G 45/08

(52) U.S. Cl. CPC B01J 27/0515; C10G 45/08; C10G 45/12; B01J 37/20

(57) ABSTRACT

The invention relates to the preparation of catalyst precursor using an alkane-sulphonic acid metal salt, use of alkane-sulphonic acid for the preparation of catalyst precursor and the use of such a catalyst precursor in chemical reactions for the production of fine chemicals in the chemical industry, particularly in the refining industry.

The present invention relates to the field of supported metal catalysts and more particularly to the preparation of supported metal catalysts. The invention more specifically relates to an improved method for preparing such supported metal catalysts.

In the chemical industry, and particularly in the petrochemical industry, supported metal catalysts are widely and commonly used, for example, for hydrotreating reactions.

Thus, supported metal catalysts are now used in particular for the production of fine chemicals in the chemical industry, for example in the refining industry, where they are known to be customarily used for hydrotreating reactions, and more particularly for hydrotreating hydrocarbon fractions.

Hydrotreating consists of converting, under appropriate conditions such as in the presence of hydrogen, organic sulphur compounds into hydrogen sulphide, which is called hydrodesulphurisation (FOS). Hydrotreating also consists of converting organic nitrogen compounds into ammonia, with the operation then being called hydrodenitrogenation (HDN). These hydrotreating reactions are most often conducted in the presence of one or more catalysts.

These catalysts are typically supported metal catalysts and generally comprise one or more metals chosen from the metals in columns 3 through 12 of the IUPAC periodic table of elements, such as, but not limited to, molybdenum, tungsten, nickel, cobalt, and mixtures thereof. The most commonly-used supported metal hydrotreating catalysts include cobalt and molybdenum (CoMo catalysts), nickel and molybdenum (NiMo catalysts), and nickel and tungsten (Ni—W catalysts).

Metals in commercial catalysts, when delivered to the end user, are generally and most commonly present in their oxide form. However, these supported metal catalysts are only active in the form of metal sulphides. For this reason, before being used, the oxide forms must be transformed into sulphur forms; i.e., they must be sulphurated.

Such catalysts are manufactured industrially on very large scales and usually the metal or metals are deposited on one or more porous supports, such as, but not limited to, aluminas, silicas, or silica-aluminas.

US Patent Application No. US2013/0237734 describes the use of methanesulphonic acid for the pre-treatment of the support to improve catalyst efficacy. Subsequently, the acid-treated support is put into contact with metal to form a catalyst precursor. The metal is introduced in the form of nitrates, carbonates or metal acetates or combinations thereof. However, the method disclosed in this application does not provide a simple and effective catalyst preparation method leading directly to sulphurated supported metal catalysts.

US Patent Application No. US2007/0227949 discloses catalyst compositions containing sulphur, wherein the sulphur-containing compound can be selected from the mercapto compounds, thioacids, mercaptoalcohols, sulfoxides, ammonium thiocyanates and thio-ureas, polysulphide or elemental sulphur, and the inorganic sulphur compounds. The sulphur compound is present as a sulphur compound that is not bonded to the metal constituent.

The drawback is that metal is deposited onto the support, and therefore already present on said support, before the reaction with the sulphur-containing compound to form metal sulphides. The activity and efficacy of the catalyst are based on the amount of metal deposited on the support and this method does not allow the amount of metal on the support to be increased, and consequently there is no improvement in the catalyst activity.

U.S. Pat. No. 4,845,068 patent relates to a metal-bearing inorganic oxide support that is dipped in a sulphurisation agent having a mercapto radical. The catalyst is active without any additional treatment or after treatment in the presence of hydrogen. In addition to the aforementioned drawbacks, the supported sulphur metal catalysts are pyrogens. Therefore, precautionary measures should be taken during transport, storage and handling of such catalysts, which increases the constraints and logistics costs.

International application WO2014/068135 relates to a zeolite material containing tin and having an MWW skeleton structure. This zeolite material is obtained by a method involving the treatment of a zeolite material containing boron in a liquid solvent system having a pH within the range of from 5.5 to 8. Said solvent system can be an organic acid and/or an inorganic acid, such as methanesulphonic acid. This treatment leads to a new zeolite material having an MWW skeleton structure with a greater interlayer distance compared to the materials in the prior art. In this description, only the support is treated with methanesulphonic acid and this does not lead to improved metal dispersion on the zeolite.

In addition to the previous drawbacks, the tremendous amount of sulphur compounds used in the pre-sulphurisation step has a direct negative impact on the environment. Therefore, improved methods are needed in order to reduce, among other things, the use of such large amounts of sulphur compounds. There is also a need for supported metal catalysts that are more stable, easier to activate, more efficient and have an appropriate amount of catalytic metal.

The above objectives are achieved in full or at least in part with the present invention which is further described below. Indeed, the Applicants have now discovered that the use of alkane-sulphonic acid metal salt is particularly well suited to the preparation of supported metal catalysts. In addition, it has been found that such supported metal catalysts prepared with an alkane-sulphonic acid metal salt lack some or all of the disadvantages of the metal catalysts known in the prior art through known typical methods.

Thus, and among other advantages, the use of an alkane-sulphonic acid metal salt improves the amount of metal deposited on the support, thus potentially improving the catalyst activity. Additionally, alkane-sulphonic acid metal salt has a higher solubility in a water-based solution than another sulphur-containing metal salt compound, which allows for improved dispersion of the metal on the surface of the support.

In addition, the fact that the metal is associated with an alkane-sulphonate ion greatly facilitates the necessary sulphurisation of the metal prior to use. This facilitation is evident in at least two aspects: it enables i) an enhanced coating of the support with metal and ii) a more efficient and faster sulphurisation of the metal.

As another advantage of the present invention, and of the fact that the alkane-sulphonic acid metal salt is a sulphur-containing compound, the quantity of sulphur-containing compounds in the pre-sulphurisation step is reduced.

As yet another advantage, the use of alkane-sulphonic acid metal salt allows for the preparation of stable, safe and non-pyrogen catalysts, leading to less difficulty and risk during storage, transport and use.

Therefore, and according to a first aspect, the present invention relates to a catalyst precursor comprising at least one porous support and at least one metal adsorbed on said support, said metal being in the form of an alkane-sulfonate metal generally having the formula (1):

(R—SO₂—O⁻)ₙ, Mn⁺ (1)

wherein:
R represents a linear, cyclic or branched saturated hydrocarbon chain comprising from 1 to 12 carbon atoms, preferably from 1 to 6 carbon atoms, preferably from 1 to 4 carbon atoms; advantageously R represents a methyl or ethyl group, preferably R represents a methyl group,
M represents a metal cation, the metal being chosen from the metals in any of columns 3 to 12 of the IUPAC periodic table of elements, and
n is an integer representing the valence of the metal atom cation.

“Catalyst precursor” in the present invention means a catalyst that is stable under storage and transport conditions and can be activated before use.

The catalyst precursor support in the present invention can be any support known to the person skilled in the art and preferably any porous support, and more preferably any refractory porous support, typically used in the field of supported catalysts and well-known to the person skilled in the art.

“Porous refractory support” means any porous catalyst support well-known to the person skilled in the art, capable of withstanding heat, in particular the effects induced by high temperatures, by bodies having a high melting point. Typical examples of porous refractory materials are the porous refractory ceramics that are well-known in the catalyst field, such as the porous zircon-based ceramics or the porous alumina-based ceramics.

More generally, and as non-limiting examples, the support is preferably chosen from among the porous refractory metal oxides. Examples of such supports include, but are not limited to, alumina, silica, zircon, magnesia, beryllium oxide, chromium oxide, titanium oxide, thorium oxide, ceramics, carbon such as carbon black, graphite, and activated carbon, as well as combinations thereof. Specific and preferred examples include amorphous silico-aluminate, crystalline silico-aluminate (zeolite), and titanium oxide supports.

According to a preferred embodiment, the support comprises a crystalline silico-aluminate compound, and specifically it consists of a crystalline silica-aluminate compound, which is commonly known as “zeolite”. Crystalline silico-aluminates usually contain micropores, mesopores and macropores.

The term “zeolite” refers to a particular group of crystalline aluminosilicates. These zeolites feature a network of silicon and aluminium oxide tetrahedrons in which aluminium and silicon atoms are arranged in a three-dimensional skeleton by sharing oxygen atoms. In the skeleton, the ratio of oxygen atoms to the total number of aluminium and silicon atoms can vary in large proportions, for example from 1 to 200. The skeleton has a negative electrovalence which is generally balanced by the inclusion of cations within the crystal, such as metal cations, alkali metals, alkaline earth metals, or hydrogen or mixtures of these cations.

Typical examples of zeolite that can be used in the present invention include the zeolites chosen among MFI, FAU, MAZ, MOR, LTL, LTA, PAR, OFF, STI, MTW, EPI, TON, MEL, IRON, and more specific examples of adequate zeolites include zeolite A, zeolite-X, zeolite-Y, the ZSM zeolites, mordenite, ω zeolites, β zeolites and other zeolites, and mixtures thereof.

In another embodiment the support includes a ZSM zeolite with an MFI skeleton. ZSM zeolite usually has a high ratio of silicon to aluminium. For example, the SiO₂/Al₂O₃ ratio in ZSM zeolite can be greater than or equal to about 5:1, for example from about 8:1 to about 200:1.

Examples of adequate ZSM zeolites include, but are not limited to, ZSM-22, ZSM-23, ZSM-5, ZSM-11, ZSM-12, ZSM-23, ZSM-35, ZSM-38, or combinations thereof.

Natural zeolites, such as ferrierite, and artificial and synthetic zeolites such as, but not limited to, the SAPO zeolites, e.g. SAPO-11 and SAPO-31, and the ALPO and MCM-41 zeolites, are examples of adequate zeolites that can be used as a support for the catalyst precursor according to the present invention.

Preferably, the support includes a zeolite and also preferably the zeolite can have a pore size of from about 3 Ångströms (3 Å or 300 pm) to about 10 Å (1 nm), preferably from about 5 Å (500 pm) to about 8 Å (800 pm).

As specified above, the metal adsorbed on the support can be any type of metal chosen from the metals in columns 3 through 12 of the IUAPC periodic table of elements, i.e. a transition metal. In a preferred embodiment, the metal is selected from columns 5 to 11, preferably 5 to 10 of the IUPAC periodic table of elements; even more preferably the metal is chosen from among vanadium, niobium, tantalum, chromium, molybdenum, tungsten, iron, ruthenium, osmium, cobalt, rhodium, iridium, nickel, palladium, platinum, and mixtures of two or more of them in any proportions.

Preferred metal mixtures include, but are not limited to, nickel-tungsten, cobalt-molybdenum, nickel-vanadium, nickel-molybdenum, molybdenum-tungsten, and nickel-cobalt. Traditionally, catalysts with a metal mix comprised of nickel and tungsten have excellent isomerisation and dearomatising properties, while also having an increased capacity to perform hydrodeoxygenation reactions and other hydrotreating reactions, particularly the hydrocracking of organic raw materials, whether they are of animal, plant, or fossil origin (petroleum hydrocarbons).

The amount of metal in the catalyst precursor in the present invention, expressed as the percentage by mass of the corresponding metal oxide relative to the total mass of the catalyst precursor generally ranges from 0.1% to 30%. The amount of metal can be measured by any method known to the person skilled in the art. For the purposes of the present invention, the amount of metal is measured by scanning electron microscopy (SEM) coupled with EDS (energy dispersion X-ray spectrometry). EDS system software is used to analyse the energy spectrum to determine the abundance of particular elements. The EDS can be used to find the chemical composition of materials up to a point size of a few micrometres, and therefore create elemental composition maps.

The preferred catalyst precursors in the present invention are, as non-limiting examples, catalyst precursors comprising platinum adsorbed on SAPO-11/Al₂O₃, or on ZSM-22/Al₂O₃, or on ZSM-23/Al₂O₃, or comprising nickel and tungsten adsorbed on Al₂O₃ or zeolite/Al₂O₃. Examples of particularly preferred catalyst precursors are Ni—W on Al₂O₃ and Ni—W on zeolite/Al₂O₃.

According to a second aspect, the present invention relates to a method for preparing the catalyst precursor as described above, comprising at least the following steps:

a) placing at least one porous support in contact with at least one alkane-sulphonic acid metal salt in a liquid medium;
b) fixing at least a portion of the metal salt to said porous support to produce a porous support on which at least a portion of the metal salt is fixed and which is the catalyst precursor;
c) separating the catalyst precursor obtained from said liquid medium; and
d) drying and retrieving the catalyst precursor.

“Fixing least a portion of the metal salt to said porous support” can be achieved by the person skilled in the art according to any method known as such, and for example by one or several of the following actions: immersion, plunging, dipping, or mixing of said porous support in a liquid medium containing at least one alkane-sulphonic acid metal salt.

Specifically, and without limitation by theory, the “fixing” step corresponds more or less to a deposition, coating, introduction, or diffusion, in the pores of the holder, of at least a portion of the metal salt on said porous support.

The “fixing” step can be performed at any temperature comprised between the laboratory temperature and 200° C., preferably between the laboratory temperature and 100° C. Heating the reaction medium improves the kinetics of the “fixing” step. Preferably the “fixing” stage is performed at laboratory temperature (i.e. ambient temperature).

The fixing step (b) can be performed according to any method commonly used by the person skilled in the art, such as, but not limited to, dipping, impregnation (wet or dry), deposition, adsorption from a solution, co-precipitation and chemical deposition in a vapour phase, preferably by impregnation, and more preferably by wet impregnation, and for example as disclosed by Acres et al. in the document “The design and preparation of catalysts”, Catalysis, Vol. 4, 1-4, (1981). The impregnation method is the preferred method.

Step b) can be performed at any temperature, typically at a temperature of from 10° C. to 100° C., preferably from 20° C. to 80° C. Step b) is altogether preferably performed under atmospheric pressure, although it can be performed under reduced pressure or, alternatively, under pressure.

Advantageously, step b) is performed while stirring, at any appropriate speed and according to any known method commonly used by the person skilled in the art, such as, but not limited to, using a blade, impeller, propeller, rotor, dual screw system, etc.

Step b) is usually performed for a few seconds to several hours, preferably for a few minutes to a few hours, usually from a few minutes to two hours. The amount of metal adsorbed (“fixed”) on the porous support is advantageously followed by the measurement of the amount of metal remaining in the alkane-sulphonic acid metal salt formulation. The remaining metal salts can be measured by various methods such as potentiometric titration or inductive coupling plasma mass spectrometry (ICP/MS), which is the preferred method.

In step b), one or more additives can be added to the formulation, such as those well known to the person skilled in the art, such as, but not limited to, those chosen among the inorganic acids such as nitric acid, hydrochloric acid, sulphuric acid, phosphoric acid, and the organic acids such as acetic acid, oxalic acid, glycolic acid, etc., as well as mixtures thereof. Phosphoric acid or its derivatives are particularly preferred acids.

Other additives that can also be added in step b) include reducing agents, wetting agents, solvents and other additives that are well-known to the person skilled in the art.

The “reducing agent” that can be added in the formulation is usually intended to increase the amount of metal adsorbed on the support which increases the activity of the future catalyst. It can also be used to facilitate the transformation of the metal sulphonate into the corresponding metal sulphide during the calcination reaction that is performed before the catalyst is used.

Usually, the reducing agent is a sulphur-containing compound which is generally selected from among, without limitation, the mercaptans, sulfoxides and thioacids. Preferably, the reducing agent is a thiocarboxylic acid, such as thioglycolic acid or thioacetic acid.

According to the invention, the molar amount of reducing agent is from 0.3 times to 3.5 times greater than the molar amount of the metal on the support. The amount of metal on the support can be measured by SEM as described above.

Step b) can be performed more than once, i.e., several times with the same solution or a different solution of metal and with the same method or a different method.

The liquid medium can be any adequate liquid medium known to the person skilled in the art and which is suitable for metal adsorption on porous substrates. Thus the liquid medium can be water or any organic liquid or a mixture of one or more organic compounds, optionally with water. Such a liquid medium can therefore be water or an organic medium or a hydro-organic medium.

In a preferred embodiment of the present invention, the liquid medium is a solvent for the alkane-sulphonic acid metal salt. In another preferred embodiment of the present invention, the liquid medium is alkane-sulphonic acid as such or the dilution solvent medium for said alkane-sulphonic acid. For example, the liquid medium can be water and in this case water is the dilution medium for the alkane-sulphonic acid and is the solvent for the alkane-sulphonic acid metal salt in question.

As a general rule, the alkane-sulphonic acid metal salt is present in a concentration of from 5 g/L⁻¹ to 2000 g/L⁻¹, preferably from 5 g/L⁻¹ to 1500 g/L⁻¹, more preferably from 50 g/L⁻¹ to 1500 g/L⁻¹, the limits being included. A concentration of less than 5 g/L⁻¹ is possible; however, the amount of metal adsorbed may not be sufficient. Similarly, a concentration of more than 2000 g/L⁻¹ is possible, provided, however, that the salt remains soluble so as to avoid insoluble particles of alkane-sulphonic acid metal salt, which could be a problem when retrieving the catalyst precursor.

As disclosed above, the alkane-sulphonic metal corresponds to the general formula (1):

(R—SO₂—O⁻)ₙ, Mⁿ⁺ (1)

wherein:
R represents a saturated, linear, cyclical or branched hydrocarbon chain comprising from 1 to 12 carbon atoms, preferably from 1 to 6 carbon atoms, preferably from 1 to 4 carbon atoms; advantageously, R represents a methyl or ethyl group, more preferably R represents a methyl group,
M represents a metal cation, the metal being chosen from the metals in any of columns 3 to 12 of the IUPAC periodic table of elements, and
n is an integer representing the valence of the metal cation.

The alkane-sulphonic metal of general formula (1) is known as such and commercially available, or can be prepared using techniques known to the person skilled in the art or prepared by adaptation of techniques known to the person skilled in the art. Such a known method is for example described by Gernon et al. in the document “Environmental benefits of methane sulphonic acid: comparative properties and benefits”, Green publication, 1(3), 127-140, (1999), where it consists simply of reacting alkane-sulphonic acid with at least one metal.

In another example, an alkane-sulphonic metal of general formula (1) can be prepared by contacting one or more corresponding metals from columns 3 to 12 of the IUPAC periodic table of elements and/or one or more compounds containing such metal or metals with one or more alkane-sulphonic acids.

This contacting can be performed at any temperature, preferably and most conveniently at ambient temperature, or at a moderate temperature, for example at a temperature capable of ranging from room temperature to 60° C.-80° C., at atmospheric pressure. This contacting results in the attack of the metal(s) and/or compound(s) containing the metal(s) by the acid(s), thereby forming one or more metal salts of formula (1) above.

Appropriate stirring can also be necessary or recommended to accelerate the formation of the desired salt of formula (1), “appropriate” meaning any stirring method known to the person skilled in the art that can accelerate the formation of the desired salt.

In the present invention, the alkane-sulphonic acid is preferably chosen from among the alkane-sulphonic acids of formula RSO₃H, wherein R is as described above. Typical alkane-sulphonic acids for use in the preparation of the salt of formula (1) include, but are not limited to, methane sulphonic acid, ethane sulphonic acid, n-propane-sulphonic acid, iso-propane-sulphonic acid, n-butane sulphonic acid, iso-butane sulphonic acid, sec-butane sulphonic acid, tert-butane sulphonic acid and mixtures of two or more of them, in any proportions.

In a preferred embodiment, the alkane-sulphonic acid is methane sulphonic acid and/or ethane-sulphonic acid; more preferably, the alkane-sulphonic acid is methane-sulphonic acid.

The present invention therefore preferably uses at least one alkane-sulphonic acid which is chosen among the linear or branched hydrocarbon-chain alkane-sulphonic acids having from 1 to 4 carbon atoms, and preferably the alkane-sulphonic acid is methane-sulphonic acid (MSA).

Any formulation comprising at least one alkane-sulphonic acid can be used in the present invention. Additionally, the alkane-sulphonic acid(s) can be used as is or diluted by various constituents as shown below. Typically such a formulation comprises from 0.01% by weight to 100% by weight of alkane-sulphonic acid, more generally from 0.01% by weight to 90% by weight, in particular from 0.01% by weight to 75% by weight of alkane-sulphonic acid, relative to the total weight of said formulation, provided that a formulation comprising 100% by weight of alkane-sulphonic acid is pure alkane-sulphonic acid, i.e. undiluted.

The concentration of the alkane-sulphonic acid(s) can vary and depends on various parameters, including the solubility of the metal salt of formula (1). The person skilled in the art will be able to adapt the concentration of alkane-sulphonic acid easily without undue effort.

Preferably, the concentration of the alkane-sulphonic acid(s) used for the formation of metal salts is quite high and for example ranges from 60% by weight to 100% by weight, preferably from about 70% by weight to 100% by weight of the alkane-sulphonic acid(s) relative to the total weight of said formulation, for the preparation of metal salts, when the metal(s) are not readily attacked by the acid(s). Alternatively, less concentrated formulations, e.g. from 0.01% by weight to 60% by weight, preferably from 0.01% by weight to 50% by weight, can be used for the preparation of metal salts from metals that are easily attacked by acids, for example when they are in powder and similar forms.

The formulation described above is for example pure alkane-sulphonic acid or an aqueous or organic or hydro-organic formulation, at a higher or lower concentration, possibly diluted before use. Alternatively, the formulation can be ready-to-use, i.e. without needing any dilution.

The known alkane-sulphonic acids and formulations comprising such acids include methane-sulphonic acid in aqueous solution, under the brand name E-PURE MSA®, marketed by Arkema, or under the brand name Lutropur®, marketed by BASF, either in ready-to-use form or diluted in water in the proportions described above.

As described above, any metal salt of formula (1) can be used to prepare the catalyst precursor. Such a preparation method comprises at least one step consisting of adsorbing (“fixing”) at least one metal on at least one porous support, by contacting at least one alkane sulphonate of formula (1) with at least one porous support.

The contact between the support and said alkane-sulphonic acid metal salt leads to the “fixing” of the metal salt on the support, i.e., to the adsorption of the metal on the support surface, said porous support then comprising metal and alkane-sulphonic groups, said groups serving as latent sulphur-based species which can be subsequently released.

The separation of the support from the liquid media in step c) is performed according to one or more methods known to the person skilled in the art, including, as non-limiting examples, solid-liquid separation, solid-liquid extraction, filtration, etc.

Non-limiting examples of such methods include evaporation by heating, distillation, vacuum setting, evaporation under a gas flow such as hydrogen, oxygen, nitrogen, or inert gas such as neon or argon, etc. Preferably, removal of the liquid media is performed by heating under nitrogen flow.

After the liquid media is removed in step c) the catalyst precursor can be dried and recovered according to known techniques. Drying is typically done for 2 hours to 20 hours at a temperature ranging from 30° C. to 300° C., preferably from 60° C. to 200° C., more preferably from 80° C. to 120° C., and generally at pressures ranging from 0.1 bar absolute (10 kPa) to 300 bar absolute (30 mPa), advantageously from 1 bar absolute (100 kPa) to 100 bar absolute (10 mPa) and more preferably between 1 bar absolute (100 kPa) and 5 bar absolute (500 kPa). Preferably, drying is performed at a temperature of 100° C. for 5 to 10 hours at a pressure of 1 bar absolute (100 Kpa).

The catalyst precursor prepared according to the method in the present invention generally comprises a quantity of metal, expressed as a mass percentage of the corresponding metal oxide relative to the total mass of the catalyst precursor, comprised between 0.1% by weight and 30% by weight, preferably from 1% by weight to 30% by weight, more preferably from 5% by weight to 20% by weight.

The catalyst precursor in the present invention obtained in step d) thus comprises one or more metals in combination with alkane-sulphonic groups that represent a latent source of sulphur that can be used in subsequent catalytic reactions. The catalyst precursor in the present invention is stable and ready for storage, transport and handling.

According to a third aspect, the present invention also relates to the use of the catalyst precursor of the present invention in the chemical industry, particularly in the petrochemical industry, and specifically in the refining industry.

When used in the chemical industry, the catalyst precursor in the present invention must advantageously be activated according to any method known to the art. The catalyst precursor according to the invention is therefore a highly convenient catalyst precursor, which is stable and safe to handle, store and transport and is activated before use just as any other known catalyst in the field.

In addition, during the activation of the catalyst precursor in the present invention, the sulphonic groups break down and form metal sulphides that represent the active form of the catalyst in a certain number of reactions that are specifically performed in the petrochemical industry, and more specifically in the refining industry.

The catalyst precursor in the present invention therefore has the advantage of avoiding any sulphurisation step during or after activation, immediately before use.

Activation of the catalyst precursor in the present invention can be performed using any known technique, such as heating at high temperature, an operation also known as calcination. Calcination is typically performed at temperatures of from 200° C. to 600° C., preferably from 300° C. to 500° C., for 1 to 6 hours, preferably for 2 to 4 hours.

According to a preferred embodiment, the temperature can be gradually increased, for example at a rate of 20 to 50° C./hour over the temperature range described above. The person skilled in the art will know the appropriate temperature and times, and even other temperatures and times outside the above ranges, for efficient calcination of the catalyst precursor in the present invention.

Calcination can be performed under an inert atmosphere, such as nitrogen, or in a gas containing oxygen, such as air, or pure oxygen, optionally in the presence of water vapour. Preferably, the calcination step is performed in an atmosphere containing oxygen.

The present invention also relates to a method for the preparation of an activated catalyst comprising a calcination step, at a calcination temperature that is well-known to the person skilled in the art, for the catalyst precursor as defined above, which leads in this manner to an activated metal sulphide catalyst. According to a preferred embodiment, the present invention relates to a method for the preparation of an activated catalyst wherein the catalyst precursor as defined above is calcinated at a temperature comprised between 200° C. and 1200° C., preferably between 400° C. and 1200° C., more preferably between 600° C. and 1200° C.

In some cases, and when appropriate, it can be advantageous to add sulphur or a source of sulphur during calcination and/or when using the catalyst in order to further increase the sulphur content of the activated catalyst. This additional supplement can be done in any manner known to the person skilled in the art, such as direct, continuous or discontinuous addition of sulphur and/or a source of sulphur such as a dialkyl disulphide (e.g. dimethyl disulphide), a thioacid, or a mercapto-acid, etc. The preferred mercapto-acids include, but are not limited to, thioglycolic acid and mercaptopropionic acid.

During the calcination and/or use of the catalyst it is also possible to add at least one reducing agent as defined above, optionally in conjunction with a reducing gas, preferably hydrogen, at high temperature.

The present invention relates to the use of said activated catalyst for the production of fine chemicals and particularly for hydrotreating hydrocarbon fractions. In the context of the present invention and as previously explained, “hydrotreating” refers to the reduction of compounds by treatment with hydrogen and comprises among other reactions: hydrogenation, hydrodesulphurisation, hydrodenitrogenation, hydrodearomatising and hydrogenolysis.

In a preferred embodiment, the catalyst obtained by said method is a pre-sulphurated catalyst.

1. A catalyst precursor comprising at least one porous support and at least one metal adsorbed on said support, said metal being in the form of an alkane-sulfonate metal of general formula (1):
(R—SO₂—O⁻)ₙ, Mⁿ⁺ (1)
wherein:
R represents a linear, cyclic or branched saturated hydrocarbon chain comprising from 1 to 12 carbon atoms, preferably from 1 to 6 carbon atoms, more preferably from 1 to 4 carbon atoms; advantageously R represents a methyl or ethyl group, preferably R represents a methyl group,
M represents a metal cation, the metal being chosen from the metals in any of columns 3 to 12 of the IUPAC periodic table of elements, and
n is an integer representing the valence of the metal atom cation.

2. The catalyst precursor according to claim 1, wherein said at least one porous support is a refractory porous support chosen from among alumina, silica, zircon, magnesia, beryllium oxide, chromium oxide, titanium oxide, thorium oxide, ceramics, carbon black, graphite, and activated carbon, as well as combinations thereof.

3. The catalyst precursor according to claim 1, wherein said at least one porous support is a refractory porous support chosen from among the amorphous silicoaluminate, crystalline silicoaluminate (zeolite) and silica-titanium oxide supports.

4. The catalyst precursor according to claim 1, wherein the at least one metal adsorbed on said support is any metal chosen from among the metals in columns 3 to 12 of the IUPAC periodic table of elements, preferably from among the metals in columns 5 to 11, more preferably from among the metals in columns 5 to 10.

5. The catalyst precursor according to claim 1, wherein said at least one metal adsorbed on said support is any metal chosen from among vanadium, niobium, tantalum, chromium, molybdenum, tungsten, iron, ruthenium, osmium, cobalt, rhodium, iridium, nickel, palladium, platinum, and mixtures of two or more of them in any proportions.

6. The catalyst precursor according to claim 1, wherein said at least one metal adsorbed on said support is a mixture chosen from among nickel-tungsten, cobalt-molybdenum, nickel-vanadium, nickel-molybdenum, molybdenum-tungsten and nickel-cobalt.

7. The catalyst precursor according to claim 1, the amount of metal in the catalyst precursor of the present invention, expressed as the mass percentage of the corresponding metal oxide relative to the total mass of the catalyst precursor, typically ranging from 0.1% to 30%.

8. A method for preparing the catalyst precursor according to claim 1, comprising at least the following steps:
a) placing at least one porous support in contact with at least one alkane-sulphonic acid metal salt in a liquid medium;
b) fixing at least a portion of the metal salt to said porous support to produce a porous support on which at least a portion of the metal salt is fixed and which is the catalyst precursor;
c) separating the catalyst precursor obtained from said liquid medium; and
d) drying and retrieving the catalyst precursor.

9. Use of the catalyst precursor according to claim 1, in the chemical industry, particularly in the petrochemical industry, and more specifically in the refining industry.

10. A method for preparing an activated catalyst wherein the catalyst precursor according to claim 1 is calcinated at a temperature comprised between 200° C. and 1200° C., preferably between 400° C. and 1200° C., more preferably between 600° C. and 1200° C.

11. The method according to claim 10, further comprising the addition of sulphur or a source of sulphur during calcination.
